(19) United States
(12) Patent Application Publication
(10) Pub. No.: US 2004/0017784 A1
(43) Pub. Date: Jan. 29, 2004

(54) Method of improving the performance between one mobile station and a base station by selective setting of the retransmission time-out values

(76) Inventor: Ingemar Backlund, Sollontuna (SE)

Correspondence Address: NIXON & VANDERHYE, PC, 1100 N GLEBE ROAD, 8TH FLOOR, ARLINGTON, VA, 22201-4714, US

(21) Appl. No.: 10/399,109

(22) PCT Filed: Oct. 5, 2001
(86) PCT No.: PCT/SE01/02187

(30) Foreign Application Priority Data
Oct. 17, 2000 (SE) 0003756-4

(51) Int. Cl. H04L 12/28

(52) U.S. Cl. 370/256; 370/455

(57) ABSTRACT

The present invention relates to a method of selective setting of retransmission time-out values in a mobile, radio communication system.

A mobile station (MS1) communicates with a base station system (BSS). The mobile station (MS1) can be in any cell in a public land mobile network (PLMN). The base station system (BSS) communicates with a serving GPRS support node (SGSN). A parameter T200D is representing retransmission time-out in downlink direction and a parameter T200U is representing retransmission time-out in uplink direction, between the mobile station (MS1) and the serving GPRS support node (SGSN). Both parameters T200D and T200U replace the T200 parameter. If the logical link control (LLC) connection is in asynchronous balanced mode (ABM) then at chosen time intervals the T200D and T200U are measured and if required negotiated.

### TECHNICAL FIELD OF THE INVENTION

The present invention relates generally to a method of setting time-out values in a mobile, radio communication system. More specifically, the method is intended to improve the performance between one mobile station (MS) and a base station (BS) (also known as a base transceiver station BTS) by selective setting of the retransmission time-out values.

### DESCRIPTION OF RELATED ART

Retransmission time-out is used frequently to handle situations were a message is sent from a sender to a receiver and no confirmation of the sent message is received from the receiver after a predetermined time. When a message, e.g. a data packet, is sent from a sender a timer is started. If an answer from the receiver, confirming the sent message, is not received within a predetermined time, based on the timer, then a time-out has occurred. The timeout will then activate a procedure, decided beforehand, e.g. a retransmission of the previously sent message. The procedure of retransmission is often used when data packets are sent from one node, the sender, to another node, the receiver, and the sender does not know if the message was received by the receiver or if the return message, sent by the receiver, was not received within a predefined time. After the retransmission of the data packet is done one of the following can happen: either an answer is received from the receiver within a predefined time or no message is received. If no message is received then another attempt to retransmit the original message can be done and if the number of retransmission has reached a certain limit then no retransmission procedure will be activated. Instead, e.g. disconnect of the connection, between the sender node and the receiver node, can be done. The number of retransmissions, before e.g. disconnect, is decided beforehand. The procedure of using retransmission with timeout is used in a numerous radio communication and computer systems.

One way of using such an arrangement is in a GPRS (General Packet Radio Services) system. In GPRS, a layered protocol architecture is introduced to provide communication services. Error detection and recovery is executed between the GPRS node SGSN (Serving GPRS Support Node) and the MS node by using the LLC (Logical Link Control) protocol. In this example, according to the ISO 7-layer model, the LLC is layer-2 and one purpose of the LLC is to transfer information on behalf of layer-3 entities residing in the MS and the SGSN. The LLC shall among other things provide different functions, e.g. sequence control, detection of transmission, format and operational errors and recovery from these errors. In this example the timer T200 Parameter, described in “ETSI TS 101 351 v8.3.0 (2000-03) Digital cellular telecommunications system (Phase2+); General Packet Radio Service (GPRS); Mobile Station—Serving GPRS Support Node (MS-SGSN) Logical Link Control (LLC) Layer specification (GSM 04.64 version 8.3.0 Release 1999)”, is used as a retransmission time-out value, and is used in the LLC protocol and it triggers after error detection the recovery of LLC PDUs (Protocol Data Units) between the SGSN LLC entity and the MS LLC entity. This is done for uplink, in this case from the MS node to the SGSN node, and for downlink, in this case from the SGSN node to the MS node. Retransmission of PDUs in the LLC protocol is triggered by several mechanisms; one mechanism is based on time-out. The LLC retransmission time-out value is set to a fixed value that can be related to the Quality of Service parameters. The value for the T200 parameter can for various Qualities of Services vary e.g. in the range from 5 to 40 seconds. Timer T200 shall include the time to transmit a frame with a certain length on the bandwidth available in the sending direction, the processing time for the PDUs in the LLC entities and the time to transmit a response frame with a certain length on the bandwidth available in the reverse direction, plus an extra value to assure that T200 is greater than the maximum value for the exchange of command and response frames. On the other hand it should not be too large because this will unnecessary delay the retransmission of the PDUs and result in degraded throughput for the LLC service user. One example is to use the following procedures and frame types described in the ETSI document, mentioned above, to make measurements to support calculation of T200 values for up and downlink directions. The sending of an I-frame is suggested to be the base for the measurements as I-frames normally are the most frequently exchanged frames between LLE's. The sending entity will, when sending the I-frame, start a timer to measure the time elapsed until a response frame is received (Tm). The A-bit in the LLC control field of an I+S or S frame will be used to trigger a response from the remote LLE. All I-frames contain the Acknowledgement Request (A) bit. The A-bit set to 1 is used by an LLE to solicit an acknowledgement (i.e., an I+S or S frame) from the peer LLE. The A-bit set to 0 is used by an LLE to indicate that the peer LLE is not requested to send an acknowledgement. At the reception of the response frame, caused by the A-bit set to 1 in the I-frame command, the timer is stopped and measured and registered as Tm. T200 is calculated as measured time (Tm) plus some delta time as T200 shall be greater than the max time to receive the response.

Another technique is described in Article “A packet media access protocol for mobile networks” where the retransmissions are controlled by the LLC-layer. The probability that data packets and/or ack-packets are lost is calculated. It is possible to set priorities based upon different retransmission probabilities and this method could be used when the system is heavily loaded.

Another technique is described in U.S. Pat. No. 5,918,002 where a selective retransmission protocol is used for computer networks including Local Area Networks (LANs) and Wide Area Networks (WANs). When the client computer detects that a data packet has not been received it calculates a round trip time for the data packet. Depending on the round trip time and the time remaining before the data packet is useless for the application a decision is made to either send the retransmission request or not.

### SUMMARY OF THE INVENTION

A problem is that the usage of fixed default values for the retransmission time out is not optimized. The fixed default values do not take into account the available and variable radio resources. Performance loss will be the result both with too long and too short values for the retransmission time-out. Another problem is that the same retransmission time-out value is set for both uplink and downlink communication, which can result, in that the retransmission time-out value will be too high so that the bandwidth will not be used efficiently.

The technique described in the above mentioned article and patent does not use different retransmission time-out values for uplink and downlink communication.

An object of the present invention is to provide ways of optimizing the usage of the bandwidth between the MS and BTS.

Another object of the invention is to provide a simple way of resetting the retransmission time-out values for both the uplink and the downlink communication between the MS and the BTS.

According to a first aspect of the invention the above mentioned object are fulfilled in a LLC retransmission timeout procedure where the T200 parameter retransmission timeout value is replaced by two retransmission time-out values, called the T200U parameter and the T200D parameter.

The invention is characterized as it appears from the appended claims.

### DESCRIPTION OF THE DRAWINGS

FIG. 1 illustrates a part of a mobile radio communication system in which the inventive method is applied.

FIG. 2 illustrates an XID parameter field format, according to prior art, which is used to send the retransmission time-out parameter between the LLC nodes in which the inventive method is applied.

FIG. 3 illustrates a model of layering the protocol in a GPRS system in which the inventive method is applied.

FIG. 4 illustrates the T200U and T200D parameters that are used by the inventive method.

FIG. 5 illustrates a communicating scheme between two LLC entities, separated by a medium in a mobile radio communication system in which the inventive method is applied.

FIG. 6 illustrates a communicating scheme between two LLC entities, separated by a medium in a mobile radio communication system in which the inventive method is applied.

FIG. 7 illustrates communicating scheme between two LLC nodes, separated by a medium in a mobile radio communication system in which the inventive method is applied.

FIG. 8 illustrates the XID frame format used to send the XID parameters between the LLC nodes in which the inventive method is applied.

FIG. 9 illustrates the SABM frame format used to send the XID parameters between the LLC nodes in which the inventive method is applied.

FIG. 10 illustrates the flowchart showing the procedure for measuring and negotiating the time-out values with in which the inventive method is applied.

### DESCRIPTION OF PREFERRED EMBODIMENTS

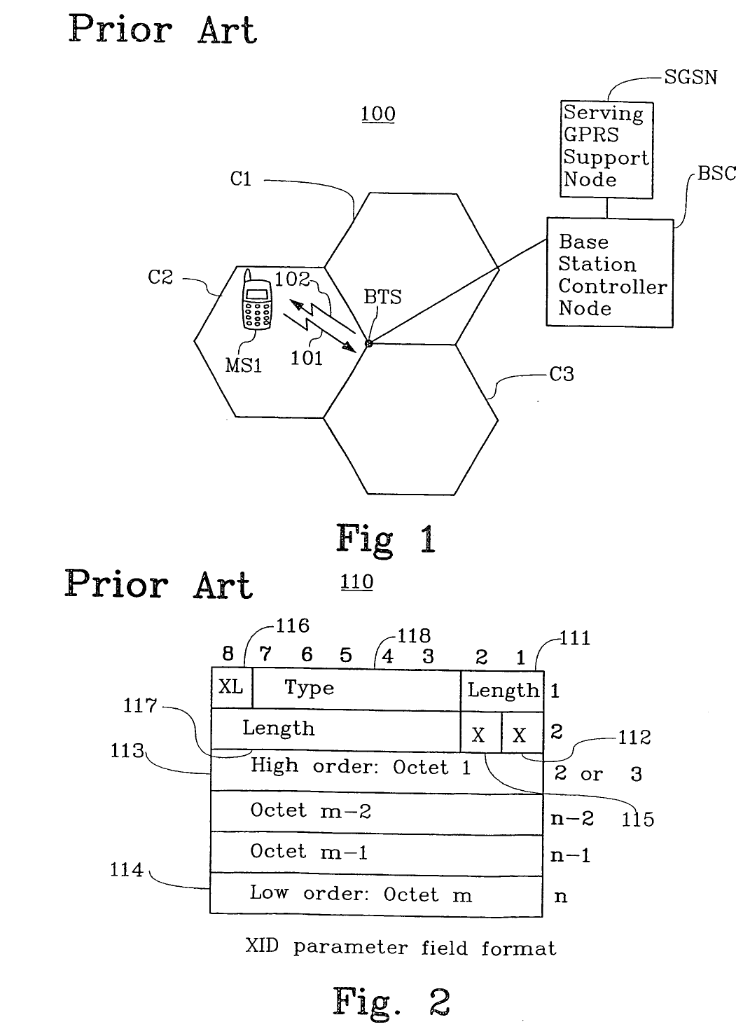

FIG. 1 illustrates a part of a mobile cellular radio system 100 in which the inventive method is applied. In this example the mobile station MS1 communicates with the base transceiver station BTS via an air interface. The communication is done uplink 101, that is from MS1 to BTS and downlink 102, that is from BTS to MS1. The MS1 can be in any cell in a public land mobile network (PLMN). BTS is connected to the base station controller node BSC via e.g. a fixed network or a satellite link. BSC is connected to the serving GPRS support node SGSN via e.g. a fixed network. The BSC and the BTS belongs to a system called the base station system (BSS). It is assumed that the bandwidth over the air interface, between MS and BSC will vary depending on e.g. MS location in the cell C1. It is also assumed that the MS can be in any cell, which in this example are C1, C2 and C3.

FIG. 2 illustrates the XID (Exchange Identification) parameter fields format 110, described in the ETSI document, mentioned above, chapter 6.4.1.6. The XID parameter fields format 110 is e.g. used in the invention for sending the retransmission time-out values from the MS1 to the SGSN and from the SGSN to the MS1. The XID parameter fields format 110 is built up of octets and the number of octets is n. Each octet consists of 8 bits, that is, bit 1 to bit 8. The XID parameter field format 110 consists of the following parts. The field 116 specifies whether the XID length field 111 and 117 is 2 bits or 8 bits long. The fields 112 and 115 contain no valid data. The data fields 113 start with octet 1, which is the highest order of the data sent and ends with octet m in field 114, which has the lowest data order. The field 118 specifies what kind of message that is sent from the sender to the receiver. This makes it possible for the receiver to recognize what kind of actions it should take and how to interpret the parameter fields of the XID.

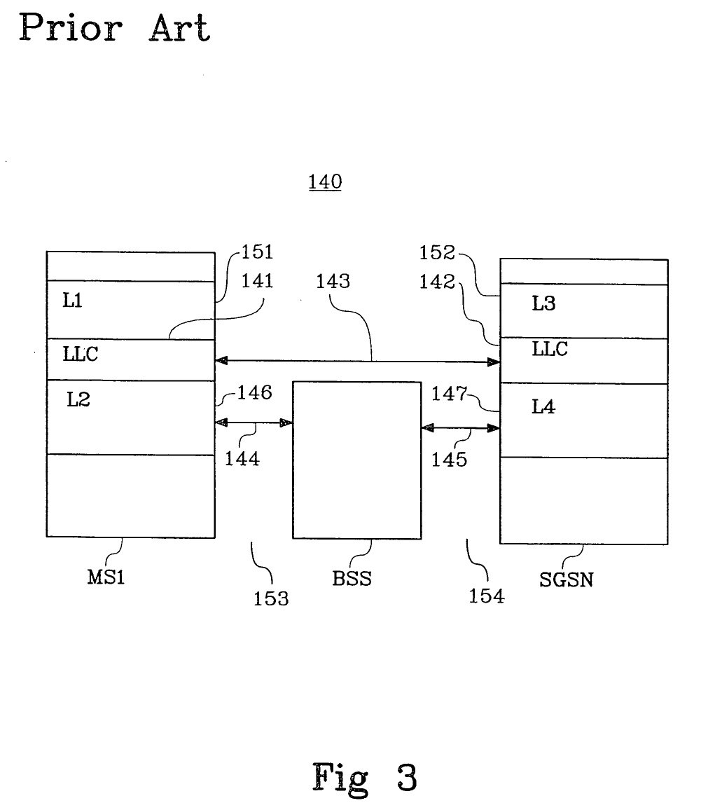

FIG. 3 shows the protocol layers 140 in a GPRS-system in which the present invention is used. There are three nodes; a mobile node represented by a mobile station represented by the MS1, a base station node represented by the BSS and a GPRS node represented by the serving GPRS support node SGSN. The LLC-protocol used in MS1 is designated LLC and is found in the field 141 of the total Link Protocol of MS1. This protocol is described in the ETSI document, mentioned above, and positioned in the Reference model as depicted in FIG. 1 of chapter 4.1. The field 141 is a layer-2 protocol in the ISO 7-layer model. Above the protocol field 141 is another layer, according to the specification mentioned above, designated L1 151. Below protocol field 141 is another layer field 146, according to the specification mentioned above, designated L2. The LLC-protocol used in SGSN is designated LLC and is found in the field 142 of the protocol suite of SGSN. This protocol is described in the ETSI document, mentioned above, chapter 4.1. The field 142 is a layer-2 protocol in the ISO 7-layer model. Above the protocol field 142 is another layer field 152, according to the specification mentioned above, designated L3. Below the protocol field 142 is another layer field 147, according to the specification mentioned above, designated L4. The logical link connection 143 represents the communication path between MS1 and SGSN by means of LLC protocols. The communication path 145 represents the path, by which the LLC protocol is using between SGSN and BSS via L4. The communication path 144 represents the path, by which the LLC protocol is using between MS1 and BSS via L2. The physical connection of the interface 154 operating between BSS and SGSN can be e.g. a copper cable, which has a fixed delay and bandwidth. The interface 153 is an air interface between MS1 and BSS. There is no physical connection, e.g. cable, connecting MS1 with BSS. The main task for LLC protocol in 140 is to convey information data between L1, field 151, entities and L3, field 152, entities and vice versa. Another task is to provide information transfer between an LLC, field 141, entity and an LLC, field 142, entity via the logical link connection 143 and vice versa. Node BSS operates between nodes MS1 and SGSN. The LLC PDUs, which are transferred between field 141 and field 142, are transparent and not affected by BSS.

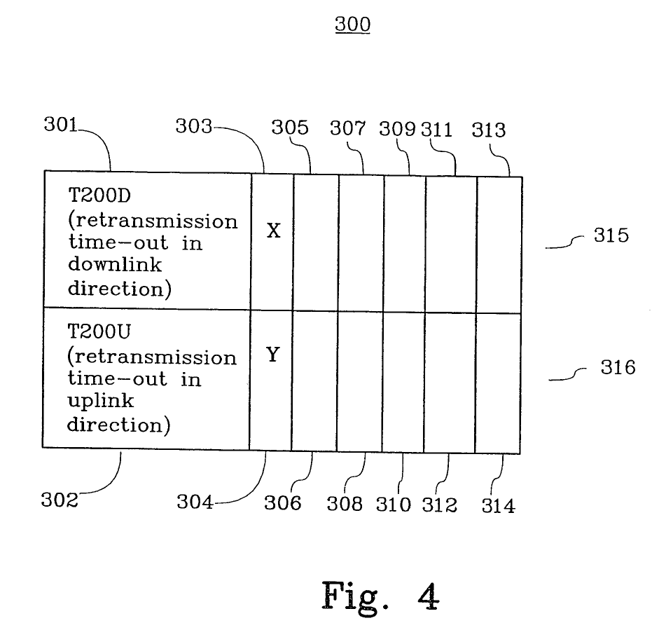

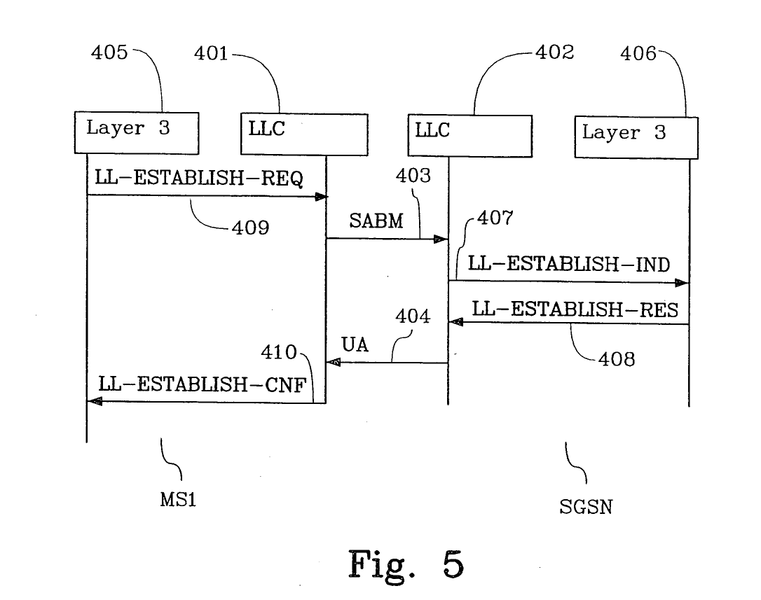

FIG. 4 illustrates the parameters used in the downlink and uplink communication according to the invention. Some LLC layer associated parameters will be included in the XID parameter field 110. According to the invention, a parameter T200D, field 301 is representing retransmission time-out in downlink direction and a parameter T200U, field 302, is representing retransmission time-out in uplink direction. Both parameters T200D and T200U replace the T200 parameter. According to the invention the type for parameter T200D is designated X in field 303 which e.g. can be 3 and for parameter T200U it is designated Y in field 304 which e.g. can be 13. Additional parameter fields are the length fields 305 and 306, which designates the actual number of octets of the value sent, the format fields 307 and 308 which designates how the value bits are arranged, the range fields 309 and 310 which describes the range of the value, the units fields 311 and 312 which describes the interpretation of the value, e.g. 10 means 1 second. Also associated is a rule to define a “sense of negotiation”, fields 313 and 314, described in the ETSI document, mentioned above, chapter 6.4.1.6. table 6, which describes if the highest or lowest value have precedence in a negotiation. E.g. if “sense of negotiation” is “up” and the sending LLC entity 401 suggests 4 seconds time-out for a connection and receiving LLC entity 402 suggests 5 seconds time-out for said connection then it is highest value, that is 5 seconds that will be the timeout for said connection. FIG. 5 illustrates only one possible way that the communication of the retransmission parameters can be performed in one direction between the sending LLC entity 401 and the receiving LLC entity 402, described in the ETSI document, mentioned above, chapter 8.5.1.2. It is presumed that the communication can be performed in the reverse direction. The SABM (Set Asynchronous Balanced Mode) command which is shown as an arrow 403 is used to set up the establishment of an ABM (Asynchronous Balanced Mode) between SGSN and MS1. According to the specification mentioned above SABM command 403 will include XID parameter fields 110, originating in layer 3 405 and LCC entity 401. According to the invention the SABM command 403 shown as an arrow with its XID parameter field 110 can be used to transmit the retransmission time-out value in downlink and uplink direction, e.g. parameter T200D 315 and parameter T200U 316. Layer 3 405 sends the LL-ESTABLISH-REQ primitive which is shown as an arrow 409 to LLC entity 401. Then LLC entity 401 sends an SABM command 403 containing the XID parameter field 110. When LLC entity 402 receives SABM command 403, from LLC entity 401, then receiving LLC entity 402 shall, after sending the LL-ESTABLISH-IND primitive shown as an arrow 407 towards layer 3 406, reset T200U or T200D, if active, and wait for the LL-ESTABLISH-RES primitive shown as an arrow 408 from layer 3 406 and send back the UA (Unnumbered Acknowledgement) frame shown as an arrow 404, containing an XID parameter field 110, to the sending LLC entity 401, which shall send the LL-ESTABLISH-CNF primitive shown as an arrow 410 back to layer 3 405. When the sending LLC entity 401 receives the UA frame shown as an arrow 404 it shall reset T200U or T200D if active.

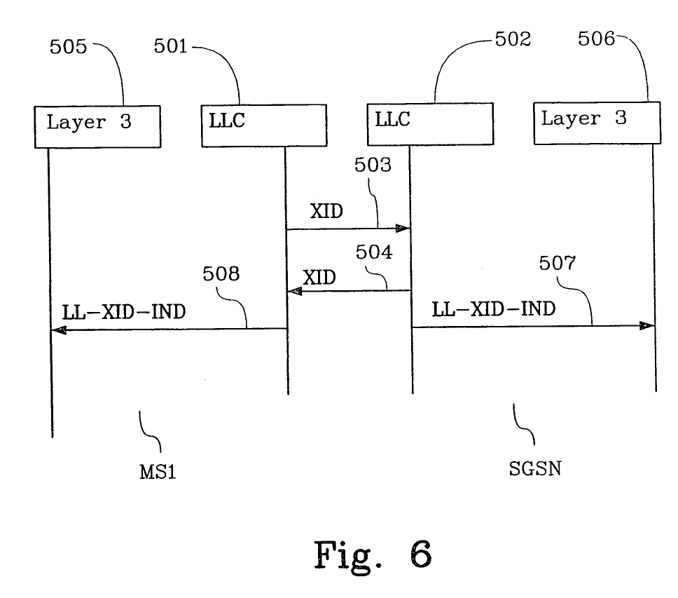

FIG. 6 illustrates only another possible way of negotiation of retransmission parameters in one direction described in the ETSI document, mentioned above, chapter 8.5.3. It is presumed that the communication can be performed in the reverse direction. According to the invention the XID frame 700 shown as an arrow 503 containing the XID parameter 110 can be used to transmit the downlink retransmission time-out value, e.g. parameter T200D 315 and the uplink retransmission time-out value e.g. parameter T200U 316. The LLC entity 502 shall upon receiving the XID frame 503 from the sending LLC entity 501 send back an XID frame shown as an arrow 504 to the sending LLC entity 501. If certain layer-3 parameters have been changed according to the ETSI document, mentioned above, chapter 8.5.3 then the LL-XID-IND primitive shown as an arrow 507 shall be sent from LLC entity 502 to layer 3 506 and the LL-XID-IND primitive shown as an arrow 508 shall be sent from LLC entity 501 to layer 3 505.

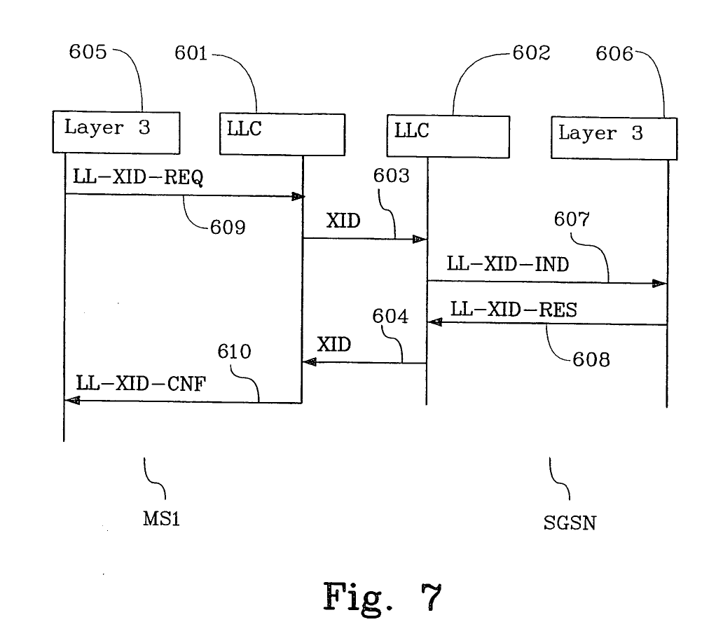

FIG. 7 illustrates only one possible way of negotiation of retransmission parameters described in the ETSI document, mentioned above, chapter 8.5.3. It is presumed that the communication can be performed in the reverse direction. The layer 3 605 is initiating the negotiation of layer 3 parameters with signal LL-XID-REQ shown as an arrow 609 towards the LLC entity 601. The LLC 601 entity can send transmission parameters in the XID frame shown as an arrow 603 towards the receiving LLC entity 602. The receiving LLC entity 602 sends a LL-XID-IND shown as an arrow 607 with layer 3 parameters towards layer 3 606. Layer 3 sends back LL-XID-RES shown as an arrow 608 towards LLC entity 602. LLC entity 602 sends back an XID frame shown as an arrow 604 towards LLC entity 601 which sends LL-XID-CNF shown as an arrow 610 towards layer 3 605.

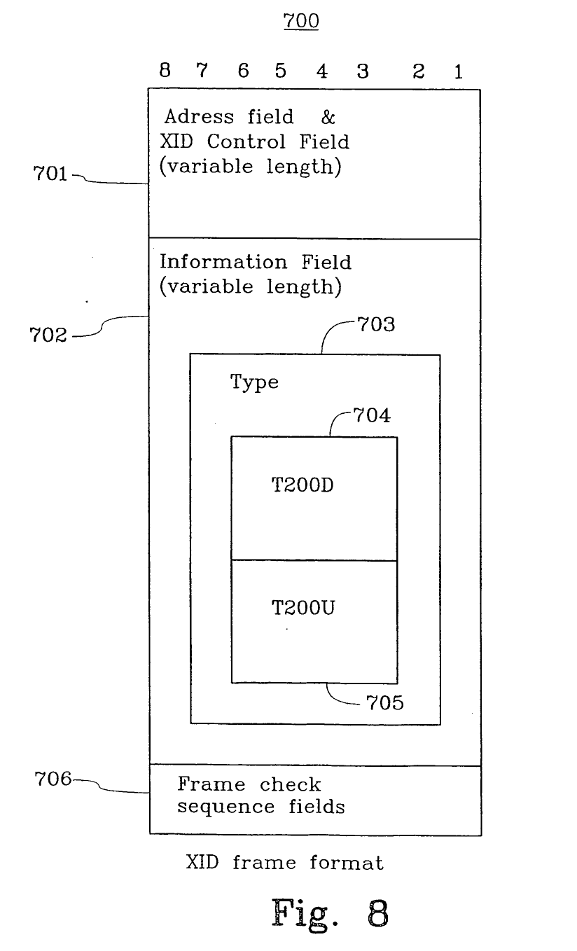

FIG. 8 illustrates the XID frame format. The XID frame format 700 consists of an address field, which consists of 1 octet, and an XID control Field 701, which can consist of maximum 36 octets, and an information field 702 which consists of e.g. one or more XID parameter field formats 110 as shown in FIG. 2, here specifically represented by the type in field 703 which is also represented by type in field 118 in FIG. 2. Type in field 703 can, according to the inventive method, consists of two time-out values T200D in field 704 and T200U in field 705 which are also represented in FIG. 4 by T200D in field 301 and T200U in field 302. The XID frame format also consists of an end field 706 consisting of a frame check sequence field. The XID parameters are included in the XID frame format 700 which is used, among other things, in the communication between said LLC entities in FIGS. 6 and 7 shown as arrows 503, 504, 603 and 604.

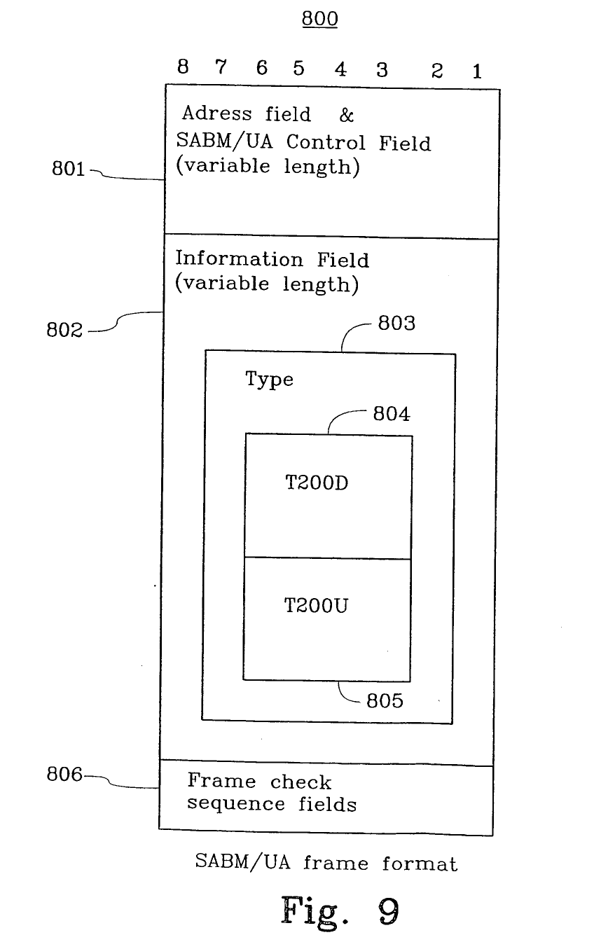

FIG. 9 illustrates the SABM/UA frame format. The SABM/UA frame format 800 consists of an address field, which consists of 1 octet, and an SABM control Field 801, which can consist of maximum 36 octets, and an information field 802 which consists of e.g. one or more XID parameter field formats 110 as shown in FIG. 2, here specifically represented by the type in field 803 which is also represented by type in field 118 in FIG. 2. Type in field 803 can, according to the inventive method, consists of two time-out values T200D in field 804 and T200U in field 805 which are also represented in FIG. 4 by T200D in field 301 and T200U in field 302. The SABM/UA frame format also consists of an end field 806 consisting of a frame check sequence field. The XID parameters are included in the SABM/UA frame format 800 which is used, among other things, in the communication between said LLC entities in FIG. 5 shown as arrows 403 and 404.

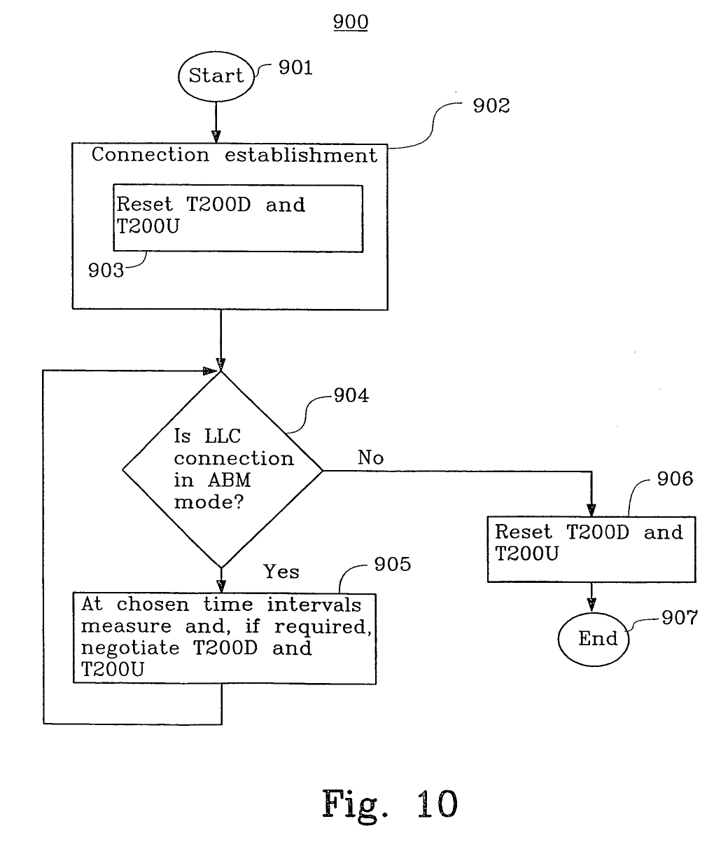

FIG. 10 illustrates a flowchart 900 in which the inventive method is applied. In this example the LLC entity is initiating a connection and enters the ABM mode and negotiates the T200U and T200D parameters as is illustrated in the flowchart 900. Start, block 901, could e.g. be a connection being setup towards MS1. During the connection establishment, block 902, the T200U and T200D are reset, block 903, see also FIG. 5. If the answer to the question if the LLC connection is in ABM mode, block 904, is “yes” then at chosen time intervals the T200D and T200U are measured and if required negotiated, block 905, by means of activities according to FIG. 6 and FIG. 7. After the measurement and, if required, negotiation, block 905, then the question if the LLC connection is in ABM mode, block 904, is performed again. If the answer to the question if the LLC connection is in ABM mode is “No” then T200D and T200U are reset, block 906 and the procedure ends, block 907.

Although the present invention and its advantages have been described in detail, it should be understood that various changes, substitutions and alterations can be made therein without departing from the spirit and scope of the invention as defined by the appended claims.

1. A method for handling time-out in a mobile radio communication system where a time-out value is sent between first and second entity communicating with each other in a first and a second direction characterized in that there is at least one time-out value used in said first direction and at least one time-out value used in said other direction for communication between said entities.

2. A method as claimed in claim 1 wherein the first entity is a mobile station node.

3. A method as claimed in claim 1 wherein the second entity is a SGSN node.

4. A method as claimed in claim 1 wherein said time-out values are used for retransmission of data.

5. A method as claimed in claim 1 wherein said at least one time-out value used in said first direction is in uplink direction.

6. A method as claimed in claim 1 wherein said at least one time-out value used in said second direction is in downlink direction.

7. A method as claimed in claim 5 wherein more than one time-out value is used in the uplink direction.

8. A method as claimed in claim 6 wherein more than one time-out value is used in the downlink direction.

9. A method as claimed in claim 7 wherein said time-out value can in said first direction of said communication has the same time-out value, while during second direction of said communication have a different timeout value.

10. A method as claimed in claim 8 wherein the said time-out value can in said second direction of said communication have the same time-out value, while during first direction of said communication have a different timeout value.
